(19) United States
(12) Patent Application Publication
(10) Pub. No.: US 2005/0256724 A1
(43) Pub. Date: Nov. 17, 2005

(54) Personalized boarding pass

(76) Inventors: Amnon Rasin, Karmey Yosef (IL); Florian Klinger, Yavne (IL); Youval Rasin, Tel Aviv (IL); Dorian Basow, Tel Aviv (IL)

Correspondence Address: DARBY & DARBY P.C., P. O. BOX 5257, NEW YORK, NY, 10150-5257, US

(21) Appl. No.: 10/503,541

(22) PCT Filed: Jan. 30, 2003
(86) PCT No.: PCT/IL03/00076

§ 371 Date: Apr. 22, 2005

Related U.S. Application Data
(60) Provisional application No. 60/353,778, filed on Feb. 1, 2002.

(51) Int. Cl. G06F 17/60

(52) U.S. Cl. 705/1

(57) ABSTRACT

An improved transportation security system and methodology, based on imaging a passenger and providing a passage and passenger specific security boarding pass, is disclosed. An improved baggage security system and methodology, based on imaging a passenger and providing a passage and passenger specific baggage claim tag, is also disclosed.

### FIELD OF THE INVENTION

The present invention relates to transportation security generally and more particularly to methodologies and systems for employing passenger images for verification purposes.

### BACKGROUND OF THE INVENTION

The following U.S. patents were found in a computerized search directed to the field of the invention:

U.S. Pat. Nos. 6,335,688; 6,137,895 and 6,106,020.

### SUMMARY OF THE INVENTION

The present invention seeks to provide methodologies and systems for employing passenger images for verification purposes.

There is thus provided in accordance with a preferred embodiment of the present invention a method of providing transportation security including imaging a passenger and providing a passage and passenger specific security boarding pass to the passenger, which boarding pass includes an image of the passenger.

There is additionally provided in accordance with a preferred embodiment of the present invention a transportation security system including a passenger imager and a boarding pass generator, providing a passage and passenger specific security boarding pass to the passenger, which boarding pass includes an image of the passenger.

There is further provided in accordance with a preferred embodiment of the present invention a system for providing transportation security including at least one of:
departure security check functionality,
departure check in functionality;
departure passport control functionality;
departure gate functionality;
transportation vehicle entry check functionality;
arrival passport control functionality; and
arrival baggage verification functionality,
   at least one of the functionalities employing passenger imaging and a passage and passenger specific security boarding pass including an image of the passenger.

Preferably, the system also includes a communication network operative to communicate at least passenger image information between at least two of the functionalities.

There is also provided in accordance with a preferred embodiment of the present invention a passage and passenger specific security boarding pass including an image of a passenger.

Preferably, the passage and passenger specific security boarding pass is printed using security ink.

In accordance with a preferred embodiment of the present invention, the image is employed as part of the at least one of the following functionalities:
departure security check functionality;
departure check in functionality;
departure passport control functionality;
departure gate functionality;
transportation vehicle entry check functionality;
arrival passport control functionality; and
arrival baggage verification functionality.

Most preferably, the image is employed as part of each of the following functionalities:
departure security check functionality;
departure check in functionality;
departure passport control functionality;
departure gate functionality;
transportation vehicle entry check functionality;
arrival passport control functionality; and
arrival baggage verification functionality.

Preferably, the image is employed as part of each of the following functionalities:
departure security check functionality;
departure check in functionality;
departure passport control functionality;
departure gate functionality;
transportation vehicle entry check functionality; and
arrival passport control functionality.

Also preferably, the image is employed as part of each of the following functionalities:
departure security check functionality;
departure check in functionality;
departure passport control functionality;
departure gate functionality; and
transportation vehicle entry check functionality.

In accordance with a preferred embodiment of the present invention, the passage and passenger specific security boarding pass is employed as part of at least one of the following functionalities:
departure security check functionality;
departure check in functionality;
departure passport control functionality;
departure gate functionality;
transportation vehicle entry check functionality;
arrival passport control functionality; and
arrival baggage verification functionality.

Preferably, the method also includes employing automatic feature recognition for comparing a stored image of the passenger with a current image of the passenger.

More preferably, the use of automatic feature recognition for comparing a stored image of the passenger with a current image of the passenger is employed in at least one of the at least one of the functionalities:
departure security check functionality;
departure check in functionality;
departure passport control functionality;
departure gate functionality;
transportation vehicle entry check functionality;
arrival passport control functionality; and
arrival baggage verification functionality.

There is further provided in accordance with a preferred embodiment of the present invention a method of providing baggage security including imaging a passenger checking in a piece of baggage and attaching a passage and passenger specific security baggage claim tag to the piece of baggage, which baggage claim tag includes an image of the passenger.

There is additionally provided in accordance with a preferred embodiment of the present invention a baggage security system including a passenger imager and a baggage claim tag generator, providing a passage and passenger specific security baggage claim tag, which baggage claim tag includes an image of the passenger.

Preferably, the passage and passenger specific security baggage claim tag is employed as part of at least one of the following functionalities: departure check in functionality and arrival baggage verification functionality.

More preferably, the passage and passenger specific security baggage claim tag is employed as part of each of the following functionalities: departure check in functionality and arrival baggage verification functionality.

Preferably, the passenger image is employed as part of at least one of the following functionalities: departure check in functionality and arrival baggage verification functionality.

More preferably, the passenger image is employed as part of each of the following functionalities: departure check in functionality and arrival baggage verification functionality.

There is also provided in accordance,with a preferred embodiment of the present invention a passage and passenger specific security baggage claim tag including an image of a passenger.

Preferably, the passage and passenger specific security baggage claim tag is printed using security ink.

### BRIEF DESCRIPTION OF THE DRAWINGS

The present invention will be understood and appreciated more fully from the following detailed description, taken in conjunction with the drawings in which:

FIGS. 1A, 1B, 1C, 1D, 1E, 1F, 1G and 1H are a series of simplified pictorial illustrations showing various functionalities forming part of a transportation security system and method constructed and operative in accordance with a preferred embodiment of the present invention;

FIG. 2 is a simplified pictorial illustration showing part of an alternative transportation security system and method constructed and operative in accordance with a preferred embodiment of the present invention;

FIGS. 3A, 3B, 3C, 3D, 3E and 3F are a series of simplified pictorial illustrations showing various functionalities forming part of a computerized alternative transportation security system and method constructed and operative in accordance with a preferred embodiment of the present invention; and

FIG. 4 is a simplified illustration showing data flows between various parts of transportation security system and method constructed and operative in accordance with a preferred embodiment of the present invention.

### DETAILED DESCRIPTION OF PREFERRED EMBODIMENTS

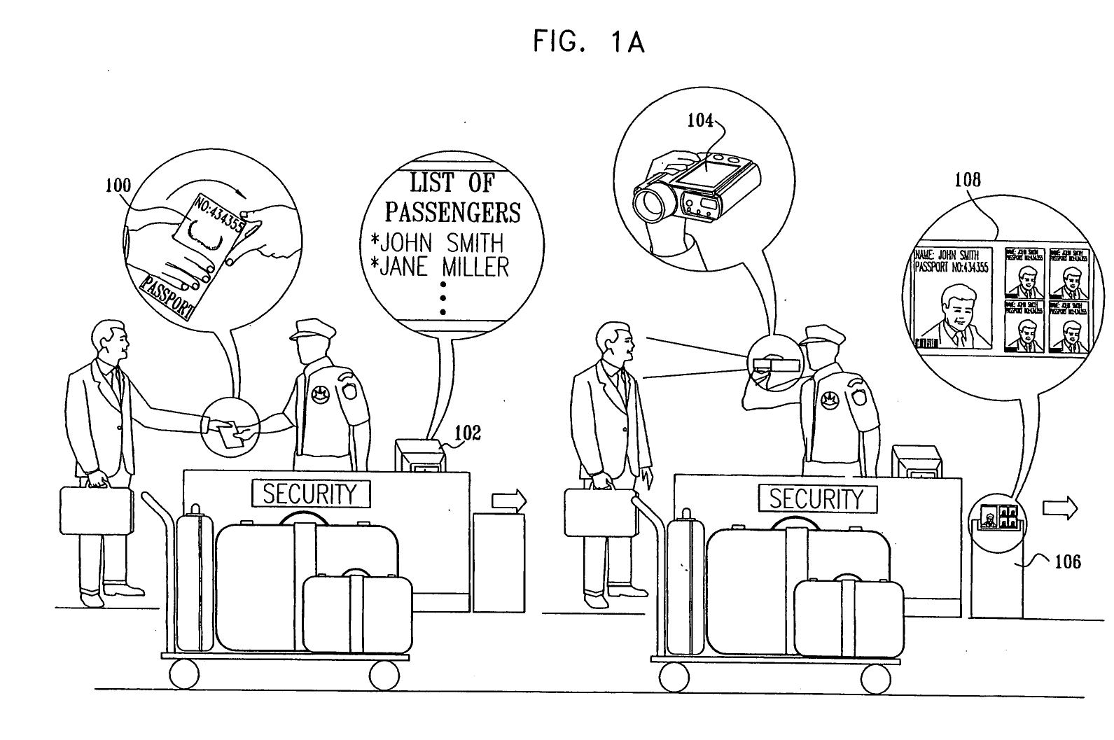

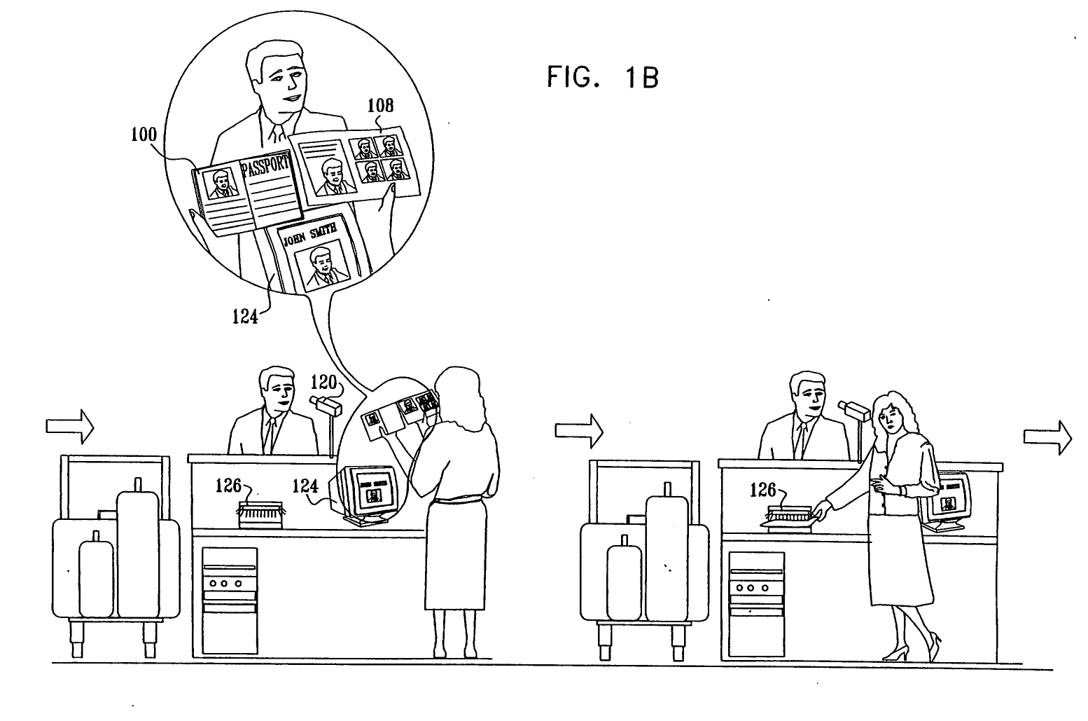

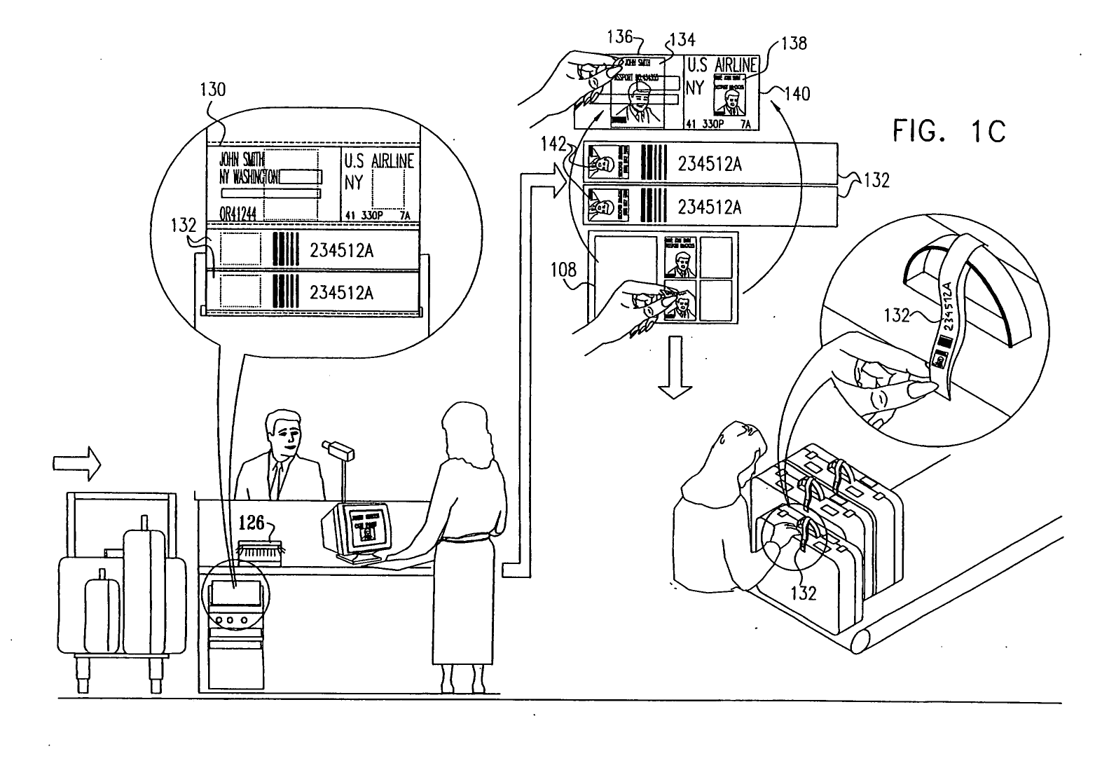

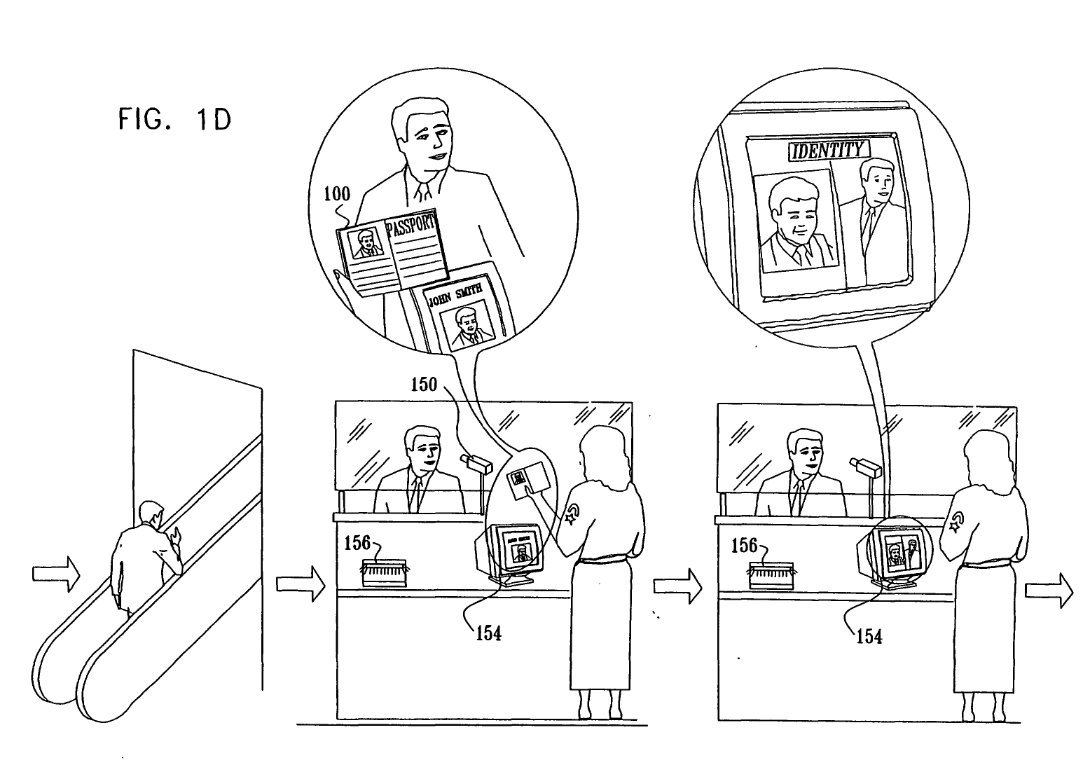

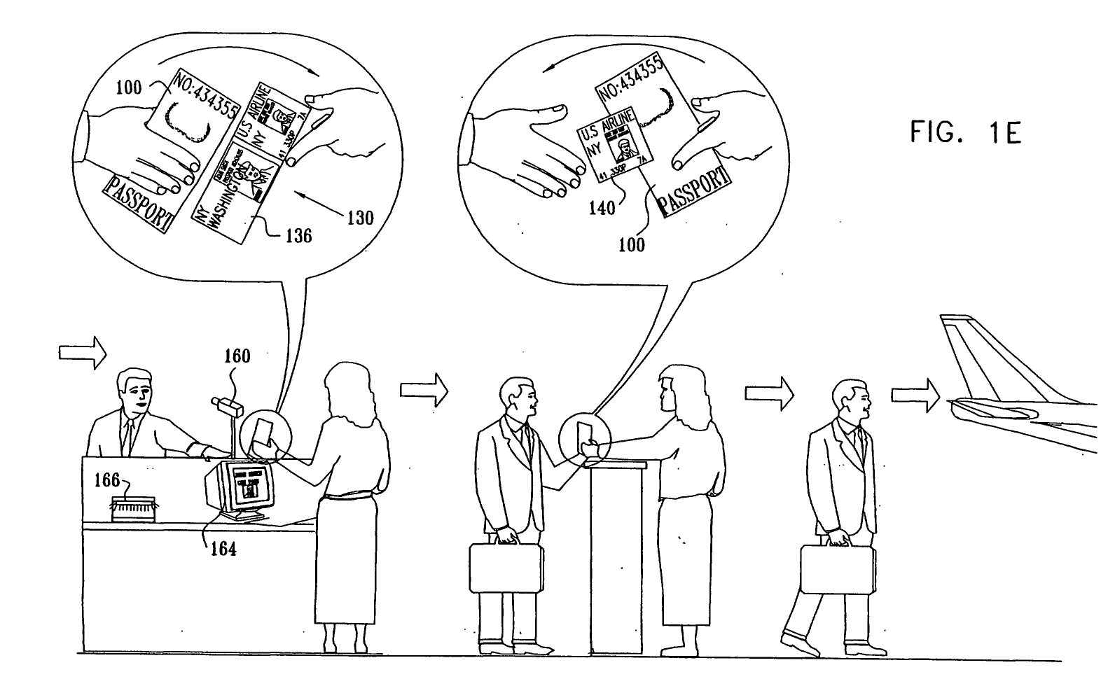

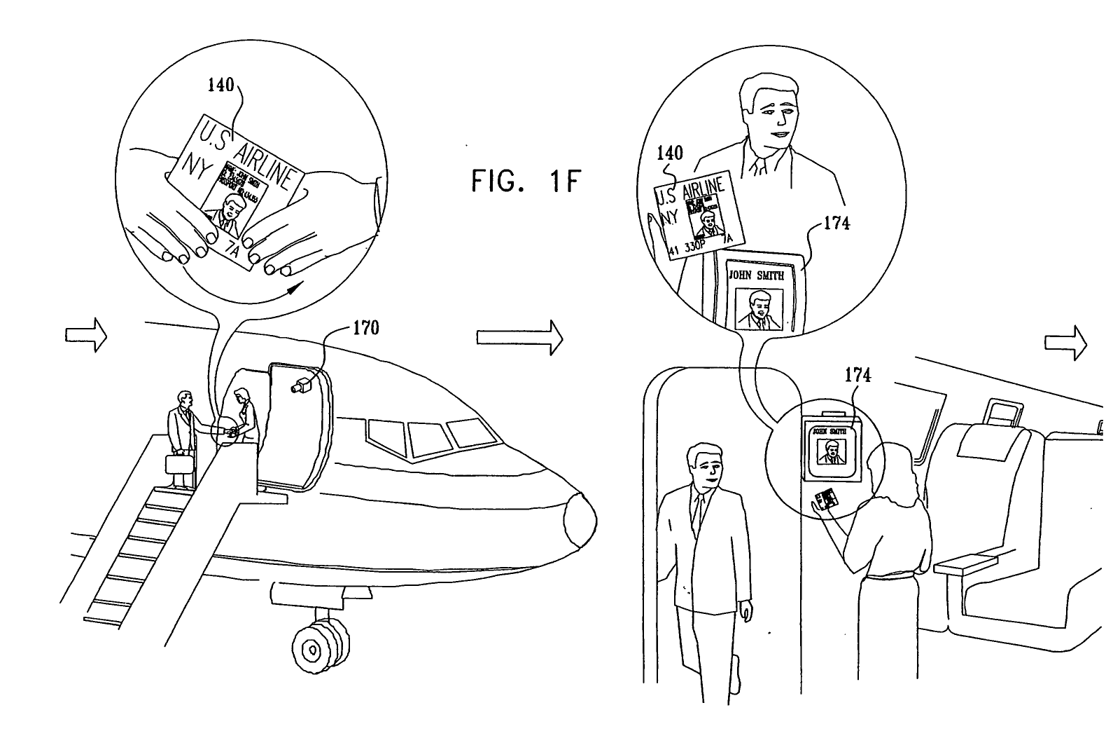

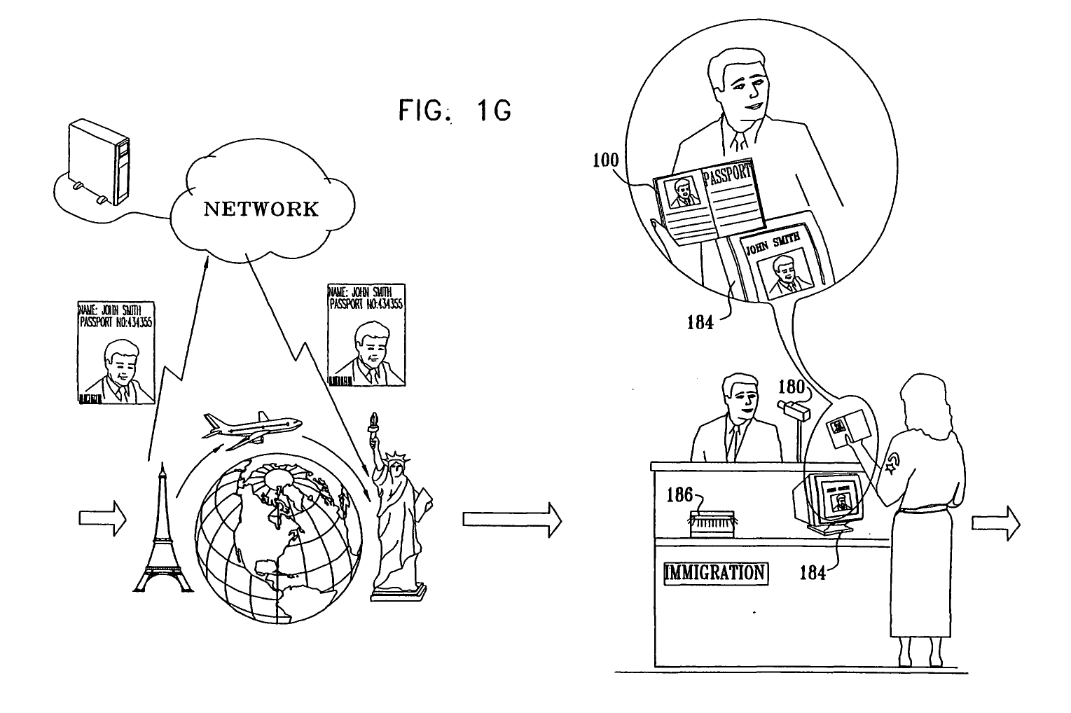

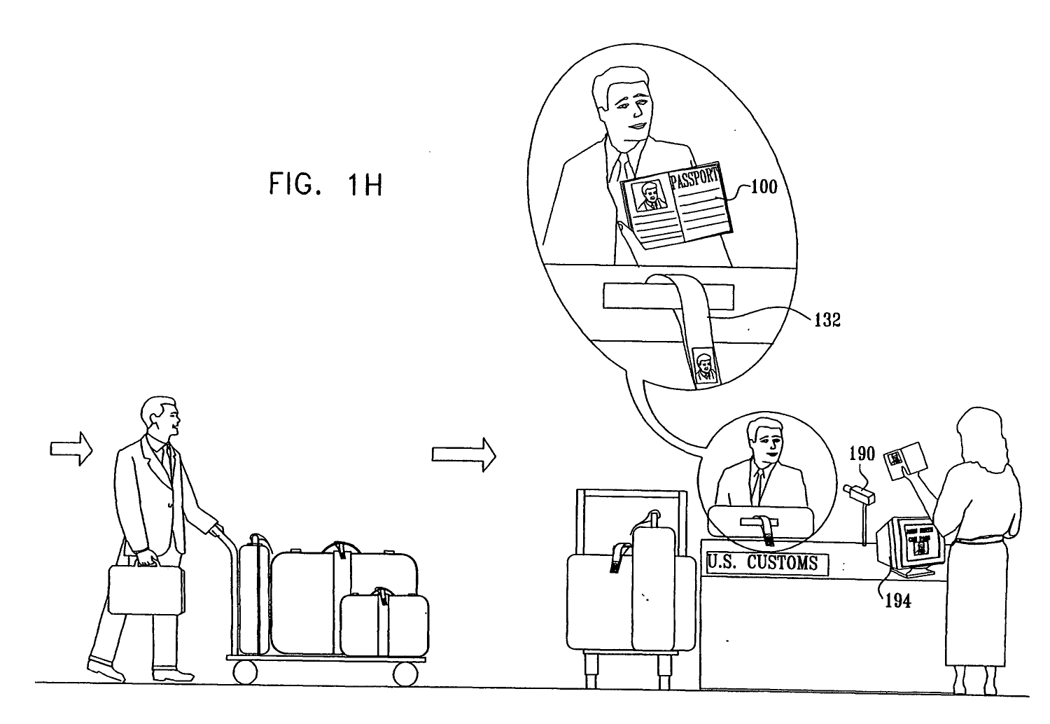

Reference is now made to FIGS. 1A, 1B, 1C, 1D, 1E, 1F, 1G and 1H, which are a series of simplified pictorial illustrations showing various functionalities forming part of a transportation security system and method constructed and operative in accordance with a preferred embodiment of the present invention. As seen in FIG. 1A, in accordance with a preferred embodiment of the present invention, a passenger presents himself/herself at a pre-check in security checkpoint location. A security agent receives the passenger's travel document 100, such as a passport or other photo identification, and compares it with passenger data made available from other sources, preferably on a computer display 102, such as the transportation carrier's reservation system and/or an appropriate security data base. In accordance with a preferred embodiment of the present invention, the passenger is photographed, preferably by a digital camera 104, preferably having a wireless link to a local area network (not shown), which is connected to a printer 106.

Printer 106 preferably prints a set of transparent overlay stickers 108 bearing the photographed image of the passenger together with passenger identity details, such as his/her passport number. Preferably, overlay stickers 108 are printed using security ink, such as a security ink containing UV pigmentation. It is appreciated that the information contained in the set of transparent overlay stickers 108 thus connect the image of the person presenting himself/herself to the security checkpoint with passenger identity information which may have a source independent from the documents presented by the passenger.

The passenger then proceeds with his/her baggage to a check in counter, as seen in FIG. 1B. At check in, the image and other information on the passenger's travel document 100 and on the set of stickers 108 is compared with the visual appearance of the passenger by a check in person.

In accordance with a preferred embodiment of the present invention, known face recognition technology may also be employed for this functionality. In such a case, the passenger is imaged at the check in counter by a camera 120, which is connected via a local area network (not shown) to a face recognition system (not shown) and to a display 124. If acceptable similarity is found between the image of the passenger captured by camera 120 and the image of the passenger supplied by the camera 104 at the security checkpoint, an appropriate visual and/or other indication is provided to the check in person.

Additionally, the genuineness of the travel document 100 may be verified by the use of an automated reader 126. Additionally or alternatively, the genuineness of the stickers 108 may be verified by the use of an automated reader 126.

If the passenger's identity is suitably verified, a boarding pass 130 and baggage tags 132 are printed, as seen in FIG. 1C. Preferably, one image sticker, here designated 134, from the set of stickers 108, is non-removably affixed to overlay a main portion 136 of the boarding pass 130, while another image sticker, here designated 138, is non-removably affixed to overlay a stub portion 140 of the boarding pass 130. Additional image stickers, here designated 142, may each be non-removably affixed to overlay the baggage tags 132. It is appreciated that any other suitable technique for non-alterably and non-removably applying an image of the passenger to the boarding pass 130 and to the baggage tags 132 may be employed.

Following attachment of the image bearing baggage tags 132 to the baggage, the baggage is placed on a conveyor and the passenger may proceed to a travel document check, such as passport control, if such a check is mandated.

Preferably as part of the travel document check, which is illustrated in FIG. 1D, the image and other information on the passenger's travel document 100 is compared with the visual appearance of the passenger by a travel document check person and, additionally, may also be compared with the image of the passenger supplied by the camera 104 (FIG. 1A) at the security checkpoint.

In accordance with a preferred embodiment of the present invention, known face recognition technology may also be employed for this functionality. In such a case, the passenger is imaged at a travel document check station by a camera 150, which is connected via a local area network (not shown) to a face recognition system (not shown) and to a display 154. If acceptable similarity is found between the image of the passenger captured by camera 150 and the image of the passenger supplied by the camera 104 (FIG. 1A) at the security checkpoint, an appropriate visual and/or other indication is provided to the travel document check person.

Additionally, the genuineness of the travel document 100 may be verified by the use of an automated reader 156.

If the passenger's identity is suitably verified and his/her documents are found to be in order, the passenger is allowed to proceed to the departure gate.

At the departure gate, which is illustrated in FIG. 1E, the image and other information on the passenger's boarding pass 130 is compared with the visual appearance of the passenger by a departure gate attendant. In addition, the image and other information on the passenger's travel document 100 may be compared with the visual appearance of the passenger by the departure gate attendant.

In accordance with a preferred embodiment of the present invention, known face recognition technology may also be employed for this functionality. In such a case, the passenger is imaged at the departure gate by a camera 160, which is connected via a local area network (not shown) to a face recognition system (not shown) and to a display 164. If acceptable similarity is found between the image of the passenger captured by camera 160 and the image of the passenger supplied by the camera 104 (FIG. 1A) at the security checkpoint, an appropriate visual and/or other indication is provided to the departure gate attendant.

Additionally, the genuineness of the boarding pass 130 may be verified by the use of an automated reader 166.

If the passenger's identity is suitably verified and his/her documents are found to be in order, the main portion 136 of the passenger's boarding pass is collected, and the stub 140 is retained by the passenger, as the passenger is allowed to proceed to the transport vehicle, in this case, an aircraft.

At the entrance to the aircraft, which is illustrated in FIG. 1F, the image and other information on the passenger's boarding pass stub 140 is compared with the visual appearance of the passenger by a flight attendant or other boarding control person. In addition, the image and other information on the passenger's travel document (not shown) may be compared with the visual appearance of the passenger by the flight attendant or other boarding control person.

In accordance with a preferred embodiment of the present invention, known face recognition technology may also be employed for this functionality. In such a case, the passenger is imaged at the entrance of the aircraft by a camera 170, which is connected via a local area network (not shown) to a face recognition system (not shown) and to a display 174. If acceptable similarity is found between the image of the passenger captured by camera 170 and the image of the passenger supplied by the camera 104 (FIG. 1A) at the security checkpoint, an appropriate visual and/or other indication is provided to the flight attendant.

Additionally, the genuineness of the boarding pass stub 140 may be verified by the use of an automated reader (not shown).

If the passenger's identity is suitably verified and his/her documents are found to be in order, he is allowed to enter the aircraft.

During travel, typically as shown in FIG. 1G, the image of the passenger, typically as acquired by camera 104 (FIG. 1A) at the security checkpoint and/or by any other image acquisition device during pre-travel passenger processing, together with any other relevant passenger data, is preferably communicated to the passenger's destination for use by immigration, customs or other personnel.

As seen in FIG. 1G, preferably as part of an arrival travel document check at the destination, the image and other information on the passenger's travel document 100 is compared with the visual appearance of the passenger and with the image, typically as acquired by camera 104 (FIG. 1A), and other information received from the departure point, by a travel document check person.

In accordance with a preferred embodiment of the present invention, known face recognition technology may also be employed for this functionality. In such a case, the passenger is imaged at a travel document inspection station by a camera 180, which is connected via a local area network (not shown) to a face recognition system (not shown) and to a display 184. If acceptable similarity is found between the image of the passenger captured by camera 180, the image of the passenger supplied by the camera 104 (FIG. 1A) at the security checkpoint at departure, which was communicated in the interim to the destination, and the passenger travel document 100, an appropriate visual and/or other indication is provided to the travel document check person.

Additionally, the genuineness of the travel document 100 may be verified by the use of an automated reader 186.

If the passenger's identity is suitably verified and his/her documents are found to be in order, the passenger is allowed to proceed.

Additionally in accordance with a preferred embodiment of the present invention, a destination baggage check, such as a customs check, may be carried out, as illustrated in FIG. 1H. The image and other information on the passenger's travel document 100 is compared with the image appearing on the baggage tags 132 and with visual appearance of the passenger by a custom's official.

In accordance with a preferred embodiment of the present invention, known face recognition technology may also be employed for this functionality. In such a case, the passenger is imaged at a custom's check station by a camera 190, which is connected via a local area network (not shown) to a face recognition system (not shown) and to a display 194. If acceptable similarity is found between the image of the passenger captured by camera 190 and the image of the passenger supplied by the camera 104 (FIG. 1A) at the security checkpoint at departure, which was communicated in the interim to the destination, and which also appears on the baggage tags 134, an appropriate visual and/or other indication is provided to the customs official.

Additionally, the genuineness of the travel document 100 may be verified by the use of an automated reader (not shown). Additionally or alternatively, the genuineness of the baggage tags 132 may be verified by the use of an automated reader (not shown).

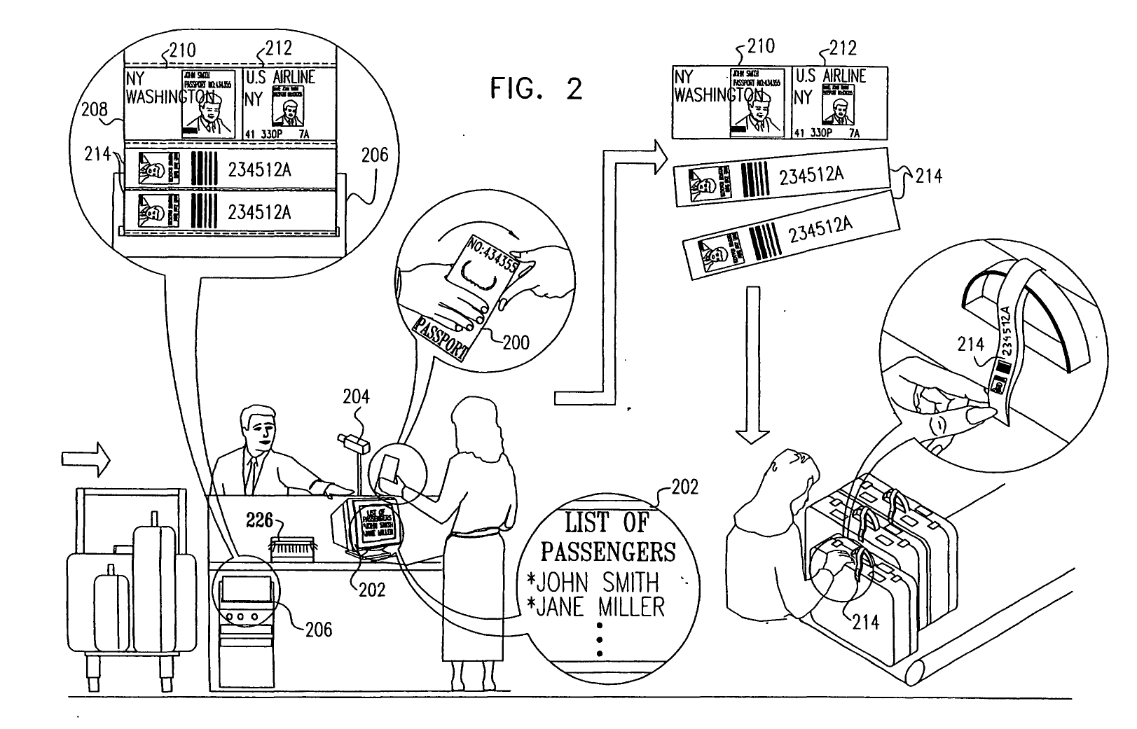

Reference is now made to FIG. 2, which is a simplified pictorial illustration showing another preferred embodiment of the present invention where portions of the system and methodology of FIGS. 1A-1C are combined into one function. As seen in FIG. 2, a passenger presents himself/herself for security check and check in at a check in counter. A check in person, who is also responsible for the security check, receives the passenger's travel document 200 and compares it with passenger data made available from other sources, preferably on a computer display 202, such as the transportation carrier's reservation system and/or an appropriate security data base. In accordance with a preferred embodiment of the present invention, the passenger is photographed, preferably by a digital camera 204, having a link to a local area network (not shown), which is connected to a printer 206.

Printer 206 preferably prints a boarding pass 208, including a main portion 210 and a stub portion 212, as well as a number of baggage tags 214, each bearing the photographed image of the passenger together with passenger identity details, such as his/her passport number. Preferably, boarding pass 208 and baggage tags 214 are printed using security ink, such as a security ink containing UV pigmentation. It is appreciated that the information contained in the boarding pass 208 and the baggage tags 214 thus connects the image of the person presenting himself/herself for check in with passenger identity information which may have a source independent from the documents presented by the passenger.

Additionally, the genuineness of the travel document 200 may be verified by the use of an automated reader 226.

Following attachment of the image bearing baggage tags 214 to the baggage, the baggage is placed on a conveyor and the passenger may proceed to a travel document check, such as passport control, if such a check is mandated.

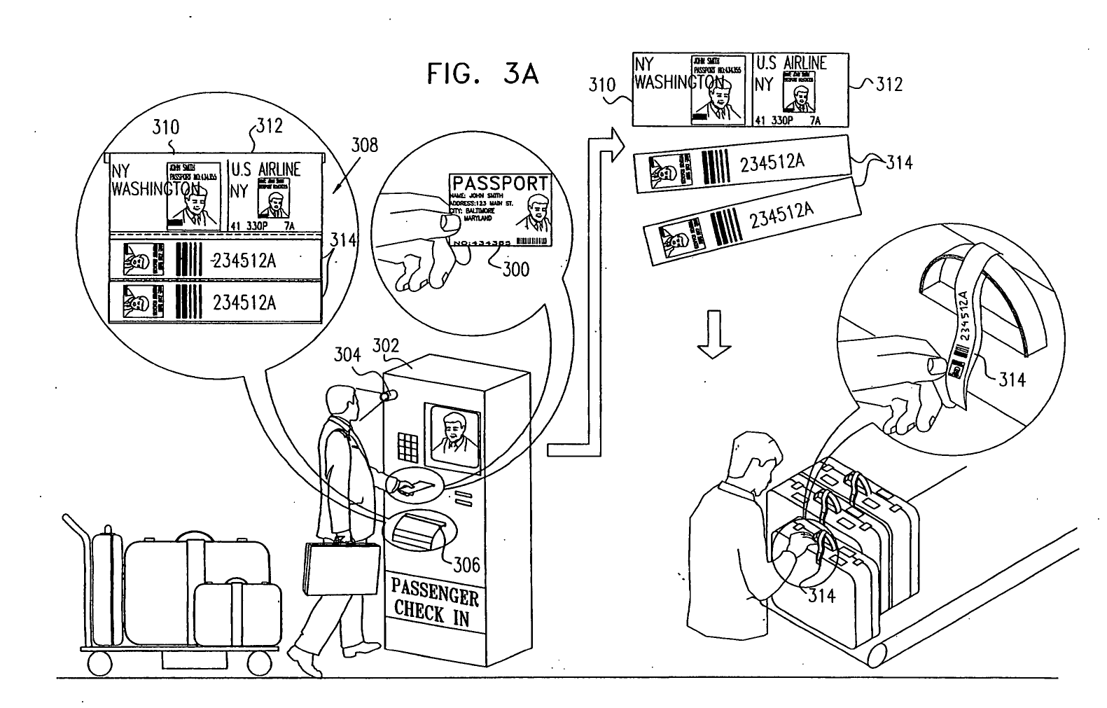

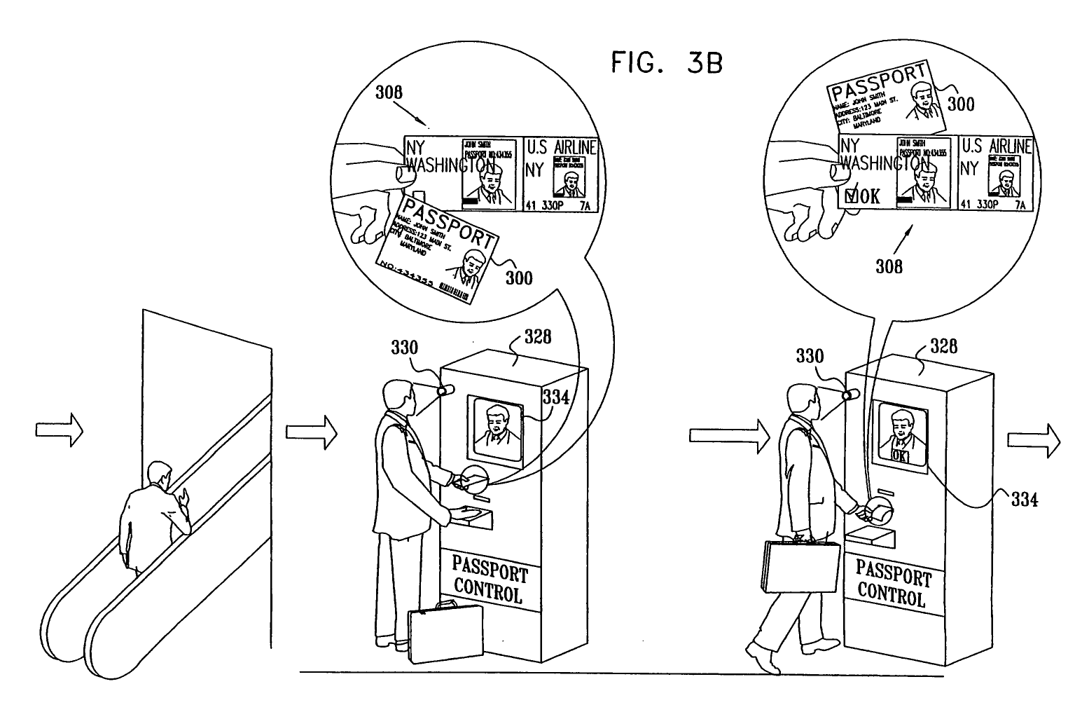

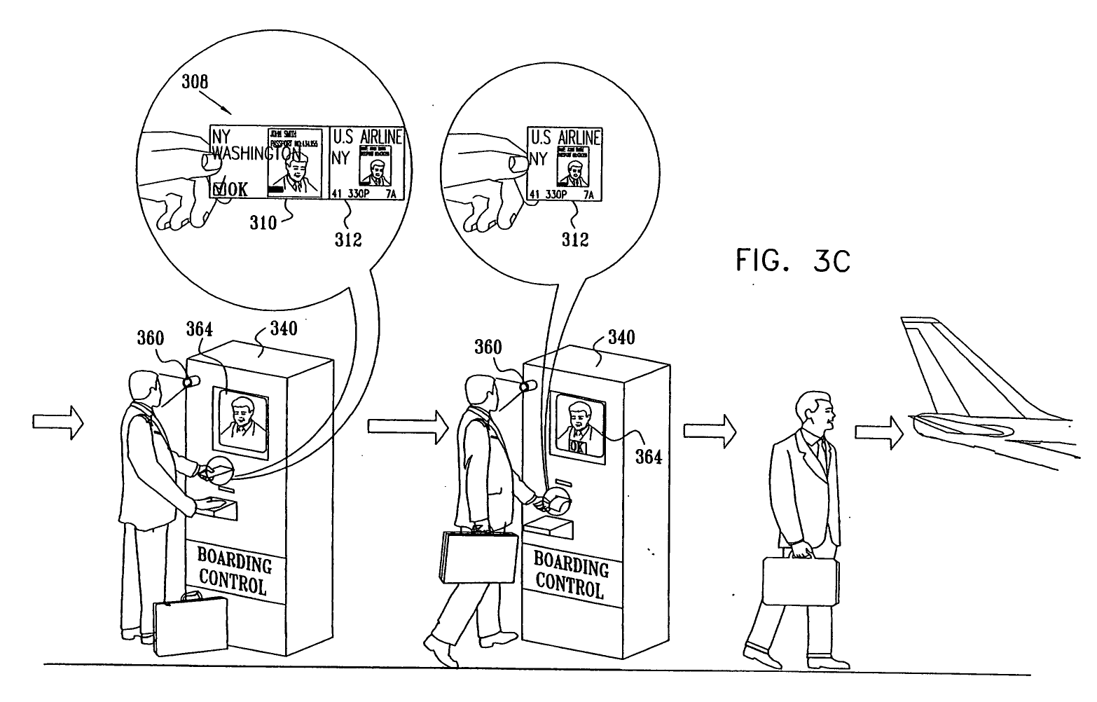

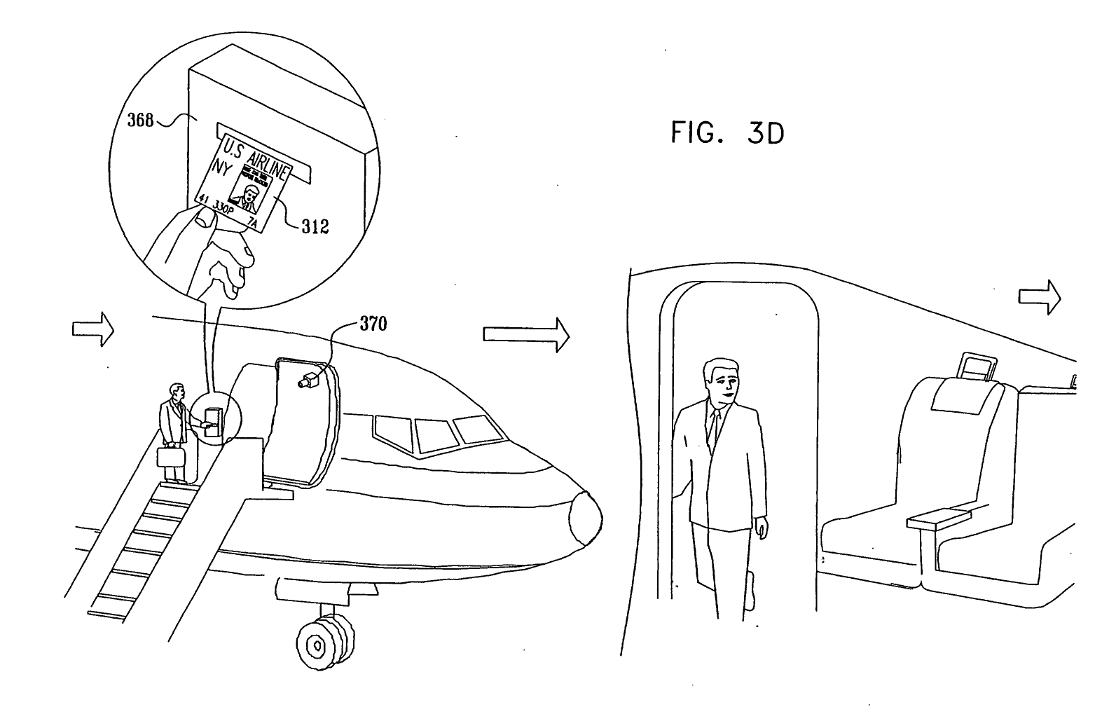

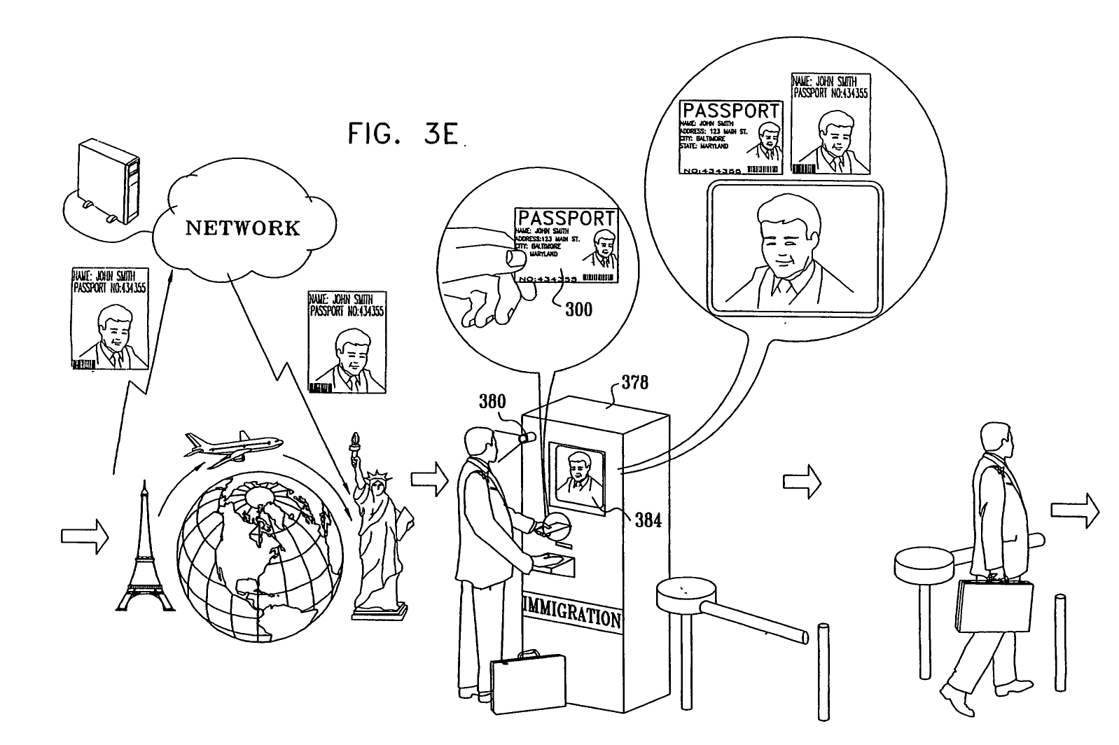

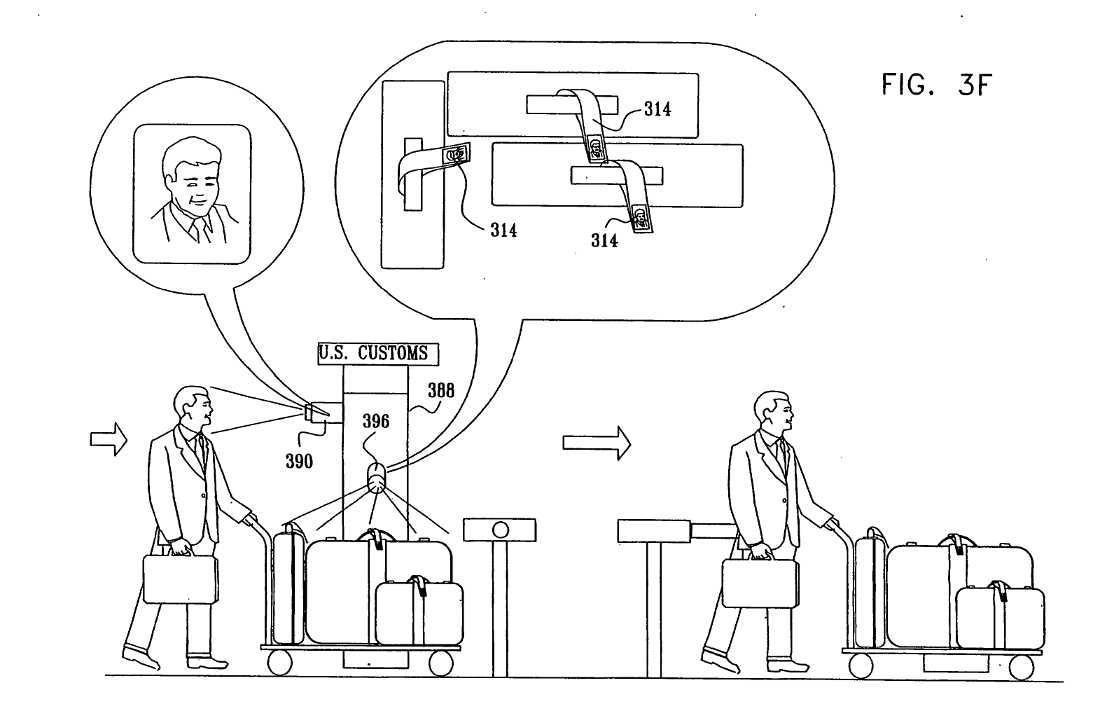

Reference is now made to FIGS. 3A, 3B, 3C, 3D, 3E, and 3F which are a series of simplified pictorial illustrations showing various functionalities forming part of an alternative transportation security system and method constructed and operative in accordance with a preferred embodiment of the present invention. The system of FIGS. 3A-3F employs automated subsystems at various stages. Portions of the system and methodology of FIGS. 1A-1H and of FIG. 2 may be combined as appropriate with portions of the system and methodology of FIGS. 3A-3F.

As seen in FIG. 3A, in accordance with a preferred embodiment of the present invention, a passenger presents his/her travel document 300, such as a passport or other photo identification, for security check and check in at a check in subsystem 302. Subsystem 302 may ask the passenger required security questions and evaluate the passenger's answers. Subsystem 302 also preferably compares the passenger's travel document 300 with passenger data made available from other sources, such as the transportation carrier's reservation system and/or an appropriate security data base.

In accordance with a preferred embodiment of the present invention, the passenger is photographed, preferably by a digital camera 304, preferably having a wireless link to a local area network (not shown), which is connected to a printer 306.

Printer 306 preferably prints a boarding pass 308, including a main portion 310 and a stub portion 312, as well as a number of baggage tags 314, each bearing the photographed image of the passenger together with passenger identity details, such as his/her passport number. Preferably, boarding pass 308 and baggage tags 314 are printed using security ink, such as a security ink containing UV pigmentation. It is appreciated that the information contained in the boarding pass 308 and the baggage tags 314 thus connects the image of the person presenting himself/herself for check in with passenger identity information which may have a source independent from the documents presented by the passenger.

Additionally, the genuineness of the travel document 300 may be verified by the use of an automated reader which may be incorporated in subsystem 302.

Following attachment of the image bearing baggage tags 314 to the baggage, the baggage is placed on a conveyor and the passenger may proceed to a travel document check, such as passport control, if such a check is mandated.

Reference is now made to FIG. 3B, which is a simplified pictorial illustration of an automated travel document verification subsystem 328. As seen in FIG. 3B, the image and other information on the passenger's travel document 300 are compared with the visual appearance of the passenger and, optionally, other biometric data, such as fingerprint data, by an automated verification subsystem 328. Subsystems of this type are known in the art and commercially available, inter alia from EDS.

In accordance with a preferred embodiment of the present invention, known face recognition technology may also be employed for this functionality. In such a case, the passenger is imaged at subsystem 328 by a camera 330, which is connected via a local area network (not shown) to a face recognition system (not shown) and to a display 334. If acceptable similarity is found between the image of the passenger captured by camera 330, the image on the passenger's travel document 300 and the image of the passenger supplied by camera 304 (FIG. 3A) at check in, an appropriate visual and/or other indication is provided to the passenger by subsystem 328.

Additionally, the genuineness of the travel document 300 may be verified by the use of an automated reader which may be incorporated in subsystem 328.

If the passenger's identity is suitably verified and his/her documents are found to be in order, the passenger is allowed to proceed to the departure gate.

At the departure gate, which is illustrated in FIG. 3C, the image and other information on the passenger's boarding pass 308 is compared with the visual appearance of the passenger by an automated departure gate subsystem 340.

In accordance with a preferred embodiment of the present invention, known face recognition technology may also be employed for this functionality. In such a case, the passenger is imaged at the departure gate by a camera 360, which is connected via a local area network (not shown) to a face recognition system (not shown) and to a display 364. If acceptable similarity is found between the image of the passenger captured by camera 360 and the image of the passenger supplied by the camera 304 (FIG. 3A) at check in, an appropriate indication is provided. Preferably, the genuineness of the boarding pass 308 is also verified by the use of an automated reader which is incorporated in subsystem 340. Conventional apparatus is employed to collect the main portion 310 of the passenger's boarding pass 308, and to return the stub 312 to the passenger, as the passenger is allowed to proceed to the transport vehicle, in this case, an aircraft.

At the entrance to the aircraft, which is illustrated in FIG. 3D, the image and other information on the passenger's boarding pass stub 312 may be compared automatically with the visual appearance of the passenger by an automated on board passenger identity verification subsystem 368.

In accordance with a preferred embodiment of the present invention, known face recognition technology may also be employed for this functionality. In such a case, the passenger is imaged at the entrance of the aircraft by a camera 370, which is connected via a local area network (not shown) to a face recognition system (not shown) and to a display (not shown). If acceptable similarity is found between the image of the passenger captured by camera 370 and the image of the passenger supplied by the camera 304 (FIG. 3A) at the security checkpoint, an appropriate visual and/or other indication is provided.

Additionally, the genuineness of the boarding pass stub 312 may be verified by the use of an automated reader which may be incorporated in subsystem 368.

If the passenger's identity is suitably verified and his/her documents are found to be in order, he is allowed to enter the aircraft.

During travel, typically as shown in FIG. 3E, the image of the passenger, typically as acquired by camera 304 (FIG. 3A) at check in and/or by any other image acquisition device during pre-travel passenger processing, together with any other relevant passenger data, is preferably communicated to the passenger's destination for use by immigration, customs or other personnel.

As seen in FIG. 3E, preferably, as part of an arrival travel document check at the destination, the image and other information on the passenger's travel document 300 is compared with the visual appearance of the passenger by an automated travel document check subsystem 378.

In accordance with a preferred embodiment of the present invention, known face recognition technology may also be employed for this functionality. In such a case, the passenger is imaged at subsystem 378 by a camera 380, which is connected via a local area network (not shown) to a face recognition system (not shown) and to a display 384. If acceptable similarity is found between the image of the passenger captured by camera 380, the image on the passenger's travel document 300 and the image of the passenger supplied by the camera 304 (FIG. 3A) at check in upon departure, which was communicated in the interim to the destination, an appropriate visual and/or other indication is provided. Additionally, the genuineness of the travel document 300 may be verified by the use of an automated reader which may be incorporated in subsystem 378.

If the passenger's identity is suitably verified and his/her documents are found to be in order, the passenger is allowed to proceed.

Additionally in accordance with a preferred embodiment of the present invention, a destination baggage check, such as a customs check, may be carried out automatically, as illustrated in FIG. 3F. The image and other information on the passenger's travel document (not shown) is compared with the image appearing on the baggage tags 314 and with visual appearance of the passenger by a baggage verification subsystem 388.

In accordance with a preferred embodiment of the present invention, known face recognition technology may also be employed for this functionality. In such a case, the passenger is imaged at subsystem 388 by a camera 390, which is connected via a local area network (not shown) to a face recognition system (not shown), to a display (not shown) and to a baggage tag reader 396, including at least one image reader. If acceptable similarity is found between the image of the passenger captured by camera 390 and the image of the passenger supplied by the camera 304 (FIG. 3A) at departure, which was communicated in the interim to the destination, and which also appears on the baggage tags 314, an appropriate visual and/or other indication is provided and the passenger is allowed to proceed.

Additionally or alternatively, the genuineness of the baggage tags 314 may be verified by the use of an automated reader which may be incorporated in subsystem 388.

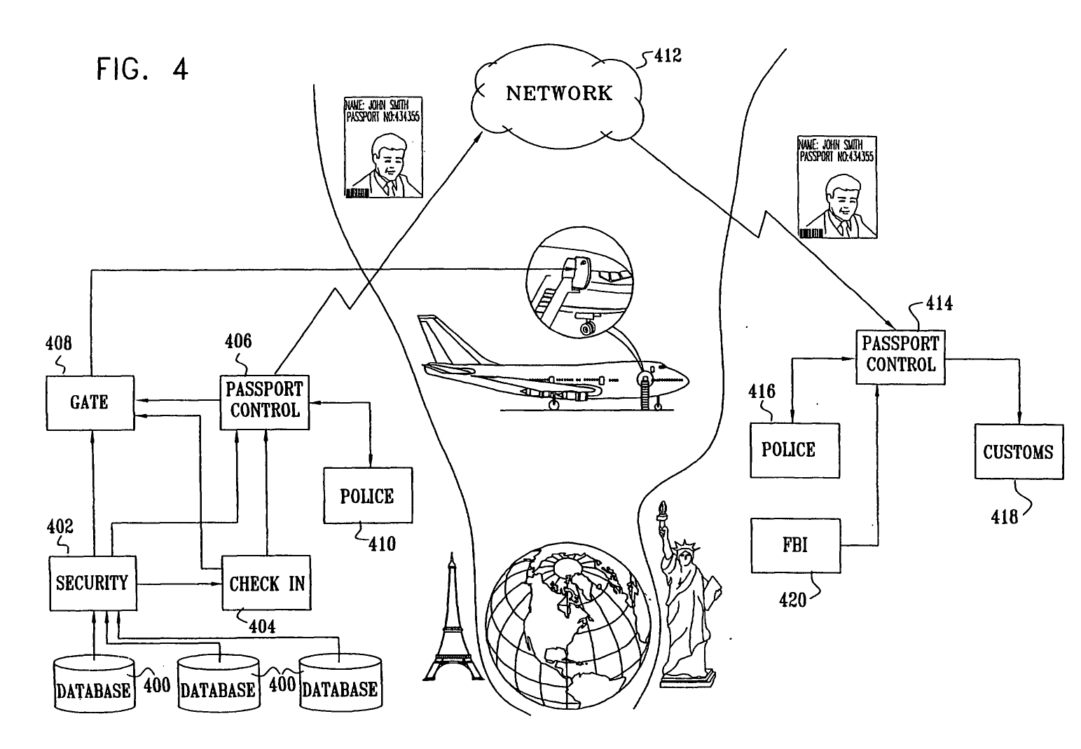

Reference is now made to FIG. 4, which is a simplified illustration showing data flows between various parts of transportation security system and method constructed and operative in accordance with a preferred embodiment of the present invention.

As seen in FIG. 4, passenger information, which preferably includes image data in most cases, is preferably communicated between various passenger screening and processing stations at departure and arrival and is communicated from a departure location to an arrival location preferably during travel, in order to enable required processing of the information at the arrival side prior to passenger arrival.

As seen in FIG. 4, passenger information, which preferably includes passenger face and other biometric images, may originate from an appropriate security or other governmental database 400, as well as from the transportation carrier's reservation/ticketing database 400, and is preferably accessible on-line in real time at security check points 402. Suitable portions of this information, as well as other passenger information, including image information acquired at security check points 402, are preferably provided to check in locations 404, travel document control points 406 and departure gates 408. Passenger information acquired at check in locations 404 is preferably provided also to travel document control points 406 and to departure gates 408. The travel document control points 406 may, of course, share information with police or other governmental databases 410 as appropriate.

Appropriate information concerning passengers, preferably including passenger face image information, is preferably provided by means of a suitable computer network 412, such as the Internet, to a destination location, where it is received by appropriate authorities, such as passport control officials at a passport control point 414. This information may be shared with a police or other governmental database 416 and with customs 418. Local data inputs from government agencies at the arrival location, such as an FBI database 420, may also be received.

It will be appreciated by persons skilled in the art that the present invention is not limited by what has been particularly shown and described hereinabove. Rather the scope of the present invention includes both combinations and subcombinations of the various features described hereinabove as well as variations and modifications which would occur to persons skilled in the art upon reading the specification and which are not in the prior art.

1. A method of providing transportation security comprising:
imaging a passenger; and
providing a passage and passenger specific security boarding pass to said passenger, which boarding pass includes an image of said passenger.

2. A method of providing transportation security according to claim 1 and comprising at least one of:
departure security check functionality;
departure check in functionality;
departure passport control functionality;
departure gate functionality;
transportation vehicle entry check functionality;
arrival passport control functionality; and
arrival baggage verification functionality,
and wherein said imaging is employed as part of said at least one of said functionalities.

3. A method of providing transportation security according to claim 1 and wherein said imaging is employed as part of each of the following functionalities:
departure security check functionality;
departure check in functionality;
departure passport control functionality;
departure gate functionality;
transportation vehicle entry check functionality;
arrival passport control functionality; and
arrival baggage verification functionality.

4. A method of providing transportation security according to claim 1 and wherein said imaging is employed as part of each of the following functionalities:
departure security check functionality;
departure check in functionality;
departure passport control functionality;
departure gate functionality;
transportation vehicle entry check functionality; and
arrival passport control functionality.

5. A method of providing transportation security according to claim 1 and wherein said imaging is employed as part of each of the following functionalities:
departure security check functionality;
departure check in functionality,
departure passport control functionality;
departure gate functionality; and
transportation vehicle entry check functionality.

6. A method of providing transportation security according to claim 1 and comprising at least one of:
departure security check functionality;
departure check in functionality;
departure passport control functionality;
departure gate functionality;
transportation vehicle entry check functionality;
arrival passport control functionality; and
arrival baggage verification functionality,
and wherein said passage and passenger specific security boarding pass is employed as part of said at least one of said functionalities.

7. A method of providing transportation security according to claim 1 and wherein said passage and passenger specific security boarding pass is employed as part of each of the following functionalities:
departure security check functionality;
departure check in functionality;
departure passport control functionality;
departure gate functionality;
transportation vehicle entry check functionality;
arrival passport control functionality; and
arrival baggage verification functionality.

8. A method of providing transportation security according to claim 1 and also comprising:
employing automatic feature recognition for comparing a stored image of said passenger with a current image of said passenger.

9. A method of providing transportation security according to claim 2 and also comprising:
employing automatic feature recognition for comparing a stored image of said passenger with a current image of said passenger in at least one of said at least one of said functionalities.

10. A method of providing transportation security according to claim 3 and also comprising:
employing automatic feature recognition for comparing a stored image of said passenger with a current image of said passenger in at least one of said functionalities.

11. A method for providing transportation security comprising at least one of:
departure security check functionality;
departure check in functionality;
departure passport control functionality;
departure gate functionality;
transportation vehicle entry check functionality;
arrival passport control functionality; and
arrival baggage verification functionality,
at least one of said functionalities employing passenger imaging and a passage and passenger specific security boarding pass including an image of the passenger.

12. A system according to claim 11 and also comprising communicating at least passenger image information over a communication network between at least two of said functionalities.

13. A method of providing baggage security comprising:
imaging a passenger checking in a piece of baggage; and
attaching a passage and passenger specific security baggage claim tag to said piece of baggage, which baggage claim tag includes an image of said passenger.

14. A method of providing baggage security according to claim 13 and comprising at least one of:
departure baggage check in functionality; and
arrival baggage verification functionality,
and wherein said imaging is employed as part of said at least one of said functionalities.

15. A method of providing baggage security according to claim 13 and wherein said imaging is employed as part of each of the following functionalities:
departure baggage check in functionality; and
arrival baggage verification functionality.

16. A method of providing baggage security according to claim 13 and comprising at least one of:
departure check in functionality; and
arrival baggage verification functionality,
and wherein said passage and passenger specific security baggage claim tag is employed as part of said at least one of said functionalities.

17. A method of providing baggage security according to claim 13 and wherein said passage and passenger specific security baggage claim tag is employed as part of each of the following functionalities:
departure check in functionality, and
arrival baggage verification functionality.

18. A transportation security system comprising:
a passenger imager; and
a boarding pass generator, providing a passage and passenger specific security boarding pass to said passenger, which boarding pass includes an image of said passenger.

19. A transportation security system according to claim 18 and comprising at least one of:
departure security check functionality;
departure check in functionality;
departure passport control functionality;
departure gate functionality;
transportation vehicle entry check functionality;
arrival passport control functionality; and
arrival baggage verification functionality,
and wherein said image is employed as part of said at least one of said functionalities.

20. A transportation security system according to claim 18 and wherein said image is employed as part of each of the following functionalities:
departure security check functionality;
departure check in functionality;
departure passport control functionality;
departure gate functionality;
transportation vehicle entry check functionality;
arrival passport control functionality; and
arrival baggage verification functionality.

21. A transportation security system according to claim 18 and wherein said image is employed as part of each of the following functionalities:
departure security check functionality;
departure check in functionality;
departure passport control functionality;
departure gate functionality;
transportation vehicle entry check functionality; and
arrival passport control functionality.

22. A transportation security system according to claim 18 and wherein said image is employed as part of each of the following functionalities:
departure security check functionality;
departure check in functionality;
departure passport control functionality;
departure gate functionality; and
transportation vehicle entry check functionality.

23. A transportation security system according to claim 18 and comprising at least one of:
departure security check functionality;
departure check in functionality;
departure passport control functionality;
departure gate functionality;
transportation vehicle entry check functionality;
arrival passport control functionality; and
arrival baggage verification functionality,
and wherein said passage and passenger specific security boarding pass is employed as part of said at least one of said functionalities.

24. A transportation security system according to claim 18 and wherein said passage and passenger specific security boarding pass is employed as part of each of the following functionalities:
departure security check functionality;
departure check in functionality;
departure passport control functionality;
departure gate functionality;
transportation vehicle entry check functionality;
arrival passport control functionality, and
arrival baggage verification functionality.

25. A transportation security system according to claim 18 and also comprising:
an automatic feature recognition subsystem for comparing a stored image of said passenger with a current image of said passenger.

26. A transportation security system according to claim 19 and also comprising:
an automatic feature recognition subsystem for comparing a stored image of said passenger with a current image of said passenger in at least one of said at least one of said functionalities.

27. A transportation security system according to claim 20 and also comprising:
an automatic feature recognition subsystem for comparing a stored image of said passenger with a current image of said passenger in at least one of said at least one of said functionalities.

28. A transportation security system comprising at least one of:
departure security check functionality;
departure check in functionality;
departure passport control functionality;
departure gate functionality;
transportation vehicle entry check functionality;
arrival passport control functionality; and
arrival baggage verification functionality,
at least one of said functionalities employing passenger imaging and a passage and passenger specific security boarding pass including an image of the passenger.

29. A system according to claim 28 and also comprising a communication network operative to communicate at least passenger image information between at least two of said functionalities.

30. A baggage security system comprising:
a passenger imager; and
a baggage claim tag generator, providing a passage and passenger specific security baggage claim tag, which baggage claim tag includes an image of said passenger.

31. A baggage security system according to claim 30 and comprising at least one of:
departure baggage check in functionality; and
arrival baggage verification functionality,
and wherein said image is employed as part of said at least one of said functionalities.

32. A baggage security system according to claim 30 and wherein said image is employed as part of each of the following functionalities:
departure baggage check in functionality; and
arrival baggage verification functionality.

33. A baggage security system according to claim 30 and comprising at least one of:
departure check in functionality; and
arrival baggage verification functionality,
and wherein said passage and passenger specific security baggage claim tag is employed as part of said at least one of said functionalities.

34. A baggage security system according to claim 30 and wherein said passage and passenger specific security baggage claim tag is employed as part of each of the following functionalities:
departure check in functionality; and
arrival baggage verification functionality.

35. A passage and passenger specific security boarding pass including an image of a passenger.

36. A security boarding pass according to claim 35 and wherein said boarding pass is printed using security ink.

37. A passage and passenger specific security baggage claim tag including an image of a passenger.

38. A security baggage claim tag according to claim 37 and wherein said baggage claim tag is printed using security ink.

39. A transportation security system according to claim 18 and wherein said boarding pass is printed using security ink.

40. A method of providing transportation security according to claim 1 and wherein said boarding pass is printed using security ink.

41. A baggage security system according to claim 30 and wherein said baggage claim tag is printed using security ink.

42. A method of providing baggage security according to claim 13 and wherein said baggage claim tag is printed using security ink.
